(19) United States
(12) Patent Application Publication
(10) Pub. No.: US 2013/0059934 A1
(43) Pub. Date: Mar. 7, 2013

(54) POLYURETHANE FOAM AND RESIN COMPOSITION

(71) Applicants: Kevin Burgess, Toronto (CA); Greg Gardin, Cambridge (CA); Chris Janzen, Milton (CA)

(72) Inventors: Kevin Burgess, Toronto (CA); Greg Gardin, Cambridge (CA); Chris Janzen, Milton (CA)

(21) Appl. No.: 13/604,043

(22) Filed: Sep. 5, 2012

Related U.S. Application Data
(60) Provisional application No. 61/531,160, filed on Sep. 6, 2011.

(51) Int. Cl. C08G 18/32; C09K 3/00; C08J 9/14

(52) U.S. Cl. 521/131; 521/156; 252/183.11

(57) ABSTRACT

A polyurethane foam and a resin composition that may be used to form the polyurethane foam are provided. The resin composition includes a first polyol based upon ethylene diamine and having about 100% ethylene oxide capping and present in an amount of from about 0.3 to about 15 parts by weight based on 100 parts by weight of the resin composition, a second polyol, and a physical blowing agent having at least 4 carbon atoms. The polyurethane foam includes the reaction product of an isocyanate component and the resin composition comprising the first and second polyol, in the presence of the physical blowing agent. A method of forming the polyurethane foam on a substrate combines the isocyanate component and the resin composition to form a reaction mixture. The reaction mixture is applied onto the substrate to form the polyurethane foam.

### RELATED APPLICATIONS

This application claims the benefit of U.S. Provisional Patent Application No. 61/531,160, filed on Sep. 6, 2011.

### BACKGROUND OF THE INVENTION

1. Field of the Invention

The subject invention generally relates to a polyurethane foam, a resin composition that may be used to form the polyurethane foam, and a method of forming the polyurethane foam on a substrate. More specifically, the subject invention relates to a polyurethane foam including the reaction product of an isocyanate component and a resin composition, in the presence of a physical blowing agent.

2. Description of the Related Art

Use of polyurethane foam throughout transportation, building, and other industries is known in the art. In the building industry, polyurethane foam is often used to thermally and/or acoustically insulate structures. As insulation, polyurethane foam functions as a seamless and maintenance-free air barrier, which provides many benefits such as prevention of moisture infiltration and mold growth, attenuation of noise, and reduction of heating and air conditioning costs.

Polyurethane foam is generally formed from an exothermic chemical reaction of a resin composition, including a polyol or polyols, and an isocyanate in the presence of a blowing agent. To form the polyurethane foam, the resin composition and the isocyanate are typically mixed in the presence of the blowing agent to form a reaction mixture and the reaction mixture is applied to an appropriate substrate as required for a particular use. The resin composition, the isocyanate, and the blowing agent, collectively known as a polyurethane system, are selected to optimize application properties of the reaction mixture as well as the performance properties of the polyurethane foam for a particular use.

When selecting the components of the polyurethane system for a particular use, such as insulation, one consideration includes the selection of components that control the rate of the exothermic chemical reaction between the resin composition and the isocyanate as well as the strength of an exotherm generated. That is, the components selected should form a reaction mixture that chemically reacts to form polyurethane and generates an exotherm fast enough and strong enough to vaporize physical blowing agent(s) present in the reaction mixture and efficiently foam the polyurethane, but not so fast and so strong that the exotherm causes the polyurethane foam to discolor, split, scorch, burn, or inadequately adhere to the substrate.

Traditionally, physical blowing agents, such as chlorofluorocarbon blowing agents (CFCs) and hydrochlorofluorocarbon blowing agents (HCFCs), were used to not only foam the polyurethane, but were also used to help control the exothermic reaction between the resin composition and the isocyanate. Due to environmental concerns, CFCs were gradually phased out in favor of HCFCs. Recently, new regulations, such as the Montreal Protocol on Substances That Deplete the Ozone Layer, statutorily mandate the phasing-out of HCFCs in favor of the utilization of non-ozone depleting physical blowing agents, such as hydrofluorocarbon blowing agents (HFCs). The phase out of CFCs and HCFCs and the subsequent utilization of HFCs has brought about challenges with respect to controlling the exothermic reaction between the resin composition and the isocyanate and the efficient formation of polyurethane foam which has the properties desired for particular uses, such as insulation.

HFCs, especially HFCs having 4 or more carbon atoms, tend to have higher boiling points and lower volatilities than CFCs and HCFCs. Simply increasing the exotherm generated by the exothermic chemical reaction between the resin composition and the isocyanate to vaporize the HFCs having 4 or more carbon atoms can cause the polyurethane foam to discolor, split, scorch, burn, inadequately adhere to the substrate, and can cause other problems. On the other hand, when the exotherm is not increased, increased amounts of the HFCs having 4 or more carbon atoms and other HFCs are typically required to form polyurethane foam having adequate density and thermal resistivity required for use as insulation. That is, when the exotherm is not increased and the HFCs having 4 or more carbon atoms are utilized as a physical blowing agent, inefficient foaming of the polyurethane occurs.

As such, there remains an opportunity to provide a resin composition, a polyurethane foam, and a method of forming the polyurethane foam on a substrate to remedy problems commonly experienced with polyurethane foams formed from HFCs having at least 4 carbon atoms.

### SUMMARY OF THE INVENTION AND ADVANTAGES

The subject invention provides a polyurethane foam and a resin composition that may be used to form the polyurethane foam. The resin composition includes a first polyol and a second polyol different from the first polyol. The first polyol is based upon ethylene diamine, has about 100% ethylene oxide capping, and is present in the resin composition in an amount of from about 0.3 to about 15 parts by weight based on 100 parts by weight of the resin composition. The polyurethane foam includes the reaction product of an isocyanate component and the resin composition including the first and second polyol, in the presence of a physical blowing agent that has at least 4 carbon atoms.

The subject invention also provides a method of forming the polyurethane foam on a substrate. The method includes the steps of providing the isocyanate component and the resin composition. The method further includes the steps of combining the isocyanate component and the resin composition to form a reaction mixture and applying the reaction mixture onto the substrate to form the polyurethane foam thereon.

The isocyanate component and the resin composition of the present invention chemically react in the presence of the physical blowing agent having at least 4 carbon atoms to efficiently form polyurethane foam having low density and excellent thermal resistivity. More specifically, the first polyol based upon ethylene diamine and having about 100% ethylene oxide capping and the second polyol chemically react with the isocyanate component at a controlled rate to generate an exotherm that is increased over exotherms of other polyurethane systems. In turn, the increased exotherm adequately vaporizes the physical blowing agent having at least 4 carbon atoms to efficiently form the polyurethane foam having minimized density and maximized thermal resistivity and, despite the increased exotherm, also having excellent coloration, adhesion, and other physical properties.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a line graph illustrating the density of the polyurethane foams of Examples 1 and 2; and

FIG. 2 is a line graph illustrating the density of the polyurethane foams of Examples 3-5.

### DETAILED DESCRIPTION OF THE INVENTION

The subject invention provides a polyurethane foam, a resin composition that may be used to form the polyurethane foam, and a method of forming the polyurethane foam on a substrate. Typically, the polyurethane foam of the present invention is used for thermal and/or acoustic insulation applications due to the minimized density and the maximized thermal resistivity thereof; however, it is to be appreciated that the polyurethane foam of the present invention may be used for many other applications as well.

The polyurethane foam of the present invention includes the reaction product of an isocyanate component and the resin composition in the presence of a physical blowing agent having at least 4 carbon atoms. The resin composition of the present invention includes a first polyol based upon ethylene diamine and having about 100% ethylene oxide capping and also a second polyol different from the first polyol. In one embodiment, the resin composition also includes the physical blowing agent having at least 4 carbon atoms, as well as any other non-isocyanate component that may be used to form the polyurethane foam. However, it is to be appreciated that, with regard to the polyurethane foam itself, the manner in which the non-isocyanate components are combined with the isocyanate component is immaterial, and the present invention does not strictly require the presence of a discrete resin composition. For example, to form the polyurethane foam, all of the components can be simultaneously combined, in which case a separate “resin composition” may not be identified.

The isocyanate component may include aliphatic isocyanates, cycloaliphatic isocyanates, araliphatic and aromatic multivalent isocyanates, or combinations thereof. Specific examples of suitable isocyanates for the isocyanate component include, but are not limited to, alkylene diisocyantes with 4 to 12 carbons in the alkylene radical, such as 1,12-dodecane diisocyanate, 2-ethyl-1,4-tetramethylene diisocyanate, 2-methyl-1,5-pentamethylene diisocyanate, 1,4-tetramethylene diisocyanate, and 1,6-hexamethylene diisocyanate; cycloaliphatic diisocyanates such as 1,3- and 1,4-cyclohexane diisocyanate, as well as any mixtures of these isomers; 1-isocyanato-3,3,5-trimethyl-5-isocyanatomethylcyclohexane (isophorone diisocyanate), 2,4- and 2,6-hexahydrotoluene diisocyanate, as well as the corresponding isomeric mixtures 4,4′, 2,2′- and 2,4′-dicyclohexylmethane diisocyanate. Additional specific examples may include aromatic diisocyanates and polyisocyanates, such as 2,4- and 2,6-toluene diisocyanate, the corresponding isomeric mixtures 4,4′-, 2,4′- and 2,2′-diphenylmethane diisocyanate, and the corresponding isomeric mixtures of 4,4′- and 2,4′-diphenylmethane diisocyanates, and polyphenylenepolymethylene polyisocyanates (polymeric MDI), as well as mixtures of polymeric MDI and toluene diisocyanates.

For purposes of the present invention, a particularly suitable isocyanate component typically includes polymeric MDI. Accordingly, in a typical embodiment, the isocyanate component includes polymeric isocyanates, such as polymeric diphenyl methane diisocyanate, and also monomeric isocyanates. Suitable isocyanates are commercially available from BASF Corporation of Florham Park, N.J.

As described above, the resin composition of the present invention includes the first polyol that is based upon ethylene diamine. Said differently, the first polyol is formed from an ethylene diamine “initiator.” An initiator, also referred to as a starter, functions as a reaction base for compounds, such as alkylene oxides, which are polymerized to form polyols, and also serves to anchor polyols during formation. As is also described above, the first polyol has about 100% ethylene oxide capping. More specifically, by “about” 100% ethylene oxide capping, it is meant that all intended capping of the first polyol is ethylene oxide capping, with any non-ethylene oxide capping resulting from trace amounts of other alkylene oxides or other impurities. As such, the capping is typically 100% ethylene oxide capping, but may be slightly lower, such as at least 99% ethylene oxide capping, depending on process variables and the presence of impurities during the production of the first polyol. The about 100% ethylene oxide capping provides substantially all primary hydroxyl groups, which typically react with the isocyanate component faster and thus generate an exotherm of greater magnitude than secondary hydroxyl groups. Generally, the faster the reaction between a polyol and the isocyanate component, the greater the exotherm. To this end, the first polyol typically reacts faster than a polyol having propylene oxide capping, as a propylene oxide-capped polyol is stearically hindered. The first polyol, based upon ethylene diamine, also has two tertiary amines, which help catalyze the chemical reaction between the first polyol and the isocyanate component and thus also contribute to the magnitude of the exotherm generated. The exotherm generated by the reaction of the first polyol, which has primary hydroxyl groups and tertiary amines, is increased over an exotherm that results from a reaction of a polyol having secondary hydroxyl groups and based on other initiators. However, the resin composition reacts with the isocyanate component in a controlled manner due to the presence of other polyols, as described further down below, and thereby utilizes the increased exotherm to effectively vaporize the physical blowing agent having at least 4 carbon atoms and efficiently foaming the polyurethane without scorching.

Typically, the first polyol has a number average molecular weight of greater than about 100, more typically from about 150 to about 800, and most typically from about 200 to about 500 g/mol. Typically, the first polyol has a nominal functionality of greater than about 2.5, more typically from about 2.8 to about 5.0, and most typically from about 3.8 to about 4.2. Typically, the first polyol has a hydroxyl value of from about 600 to about 1,300, more typically of from about 750 to about 1,150, and most typically of from about 800 to about 1,000 mgKOH/g. The number average molecular weight, nominal functionality, and hydroxyl value of the first polyol may vary outside of the ranges above, but are typically a whole or fractional value within those ranges.

For purposes of the present invention, a particularly suitable first polyol is based upon ethylene diamine and has 100% ethylene oxide capping, a molecular weight of from about 200 to about 500 g/mol, a viscosity of from about 250 to about 1,000 centipoise at 25° C. when diluted with 20 weight percent water based on 100 parts by weight of the diluted first polyol, a nominal functionality of from about 3.8 to about 4.2, and a hydroxyl value of from about 800 to about 1,000 mgKOH/g. Suitable first polyols are commercially available from BASF Corporation of Florham Park, N.J.

Typically, the first polyol is present in an amount of from about 0.3 to about 15 parts by weight, more typically from about 0.4 to about 10 parts by weight, and most typically from about 0.5 to about 7 parts by weight based on 100 parts by weight of the resin composition or, alternatively, based on 100 parts by weight of all non-isocyanate components used to make the polyurethane foam. The amount of the first polyol may vary outside of the ranges above, but is typically a whole or fractional value within those ranges. The first polyol is typically present in the aforementioned amount to provide an exotherm that effectively vaporizes the physical blowing agent having at least 4 carbon atoms and efficiently foam the polyurethane and form the polyurethane foam having minimal density and maximum thermal resistivity, as is described in further detail below.

As is also described above, the resin composition of the present invention includes the second polyol, which is different than the first polyol. The second polyol may be a polyether polyol based upon ethylene diamine. Alternatively, the second polyol may be based on other di- or polyfunctional alcohols or amines. The second polyol typically has ethylene oxide capping in an amount of from about 0 to about 99, more typically from about 10 to about 90, and most typically from about 20 to about 30%, and propylene oxide end-capping in an amount of from about 1 to about 100, more typically from about 10 to about 90, and most typically from about 70 to about 80%. That is, the second polyol provides either secondary hydroxyl groups or a combination of primary and secondary hydroxyl groups, which chemically react with the isocyanate component, the relative amounts of which can be varied to minimize possible adverse consequences of the exotherm generated by the reaction of the resin composition, in particular the first polyol, and the isocyanate component. That is, the resin composition includes the second polyol, which reacts with the isocyanate component, to counter balance the increased exotherm generated by the reaction of the first polyol and the isocyanate component and also provide a sustained exotherm to vaporize the physical blowing agent having at least 4 carbon atoms and efficiently foam the polyurethane formed therefrom as well as prevent scorching and other negative effects on the polyurethane foam. Further, when the second polyol is based on ethylene diamine, the second polyol includes two tertiary amines, which help catalyze the chemical reaction between the second polyol and the isocyanate component. The second polyol works in conjunction with the first polyol, because the second polyol includes secondary hydroxyl groups, the second polyol reacts with the isocyanate component slower than the first polyol and increases cross-linking of the polyurethane foam, thus tempering the effect of the exotherm generated by the reaction between the first polyol and the isocyanate component and thereby minimizing discoloration, splitting, scorching, burning, and poor adhesion to the substrate of the polyurethane foam formed therefrom.

Typically, the second polyol has a number average molecular weight of greater than about 100, more typically from about 250 to about 800, and most typically from about 255 to about 305 g/mol. Typically, the second polyol has a nominal functionality of greater than about 2.5, more typically from about 2.8 to about 5.0, and most typically from about 3.8 to about 4.2. Typically, the second polyol has a hydroxyl value of from about 300 to about 1,500, more typically of from about 600 to about 1,000, and most typically of from about 725 to about 825 mgKOH/g. The number average molecular weight, nominal functionality, and hydroxyl value of the second polyol may vary outside of the ranges above, but are typically a whole or fractional value within those ranges. For purposes of the present invention, a particularly suitable second polyol is based upon ethylene diamine and has 25% ethylene oxide capping, a molecular weight of from about 230 to about 330 g/mol, a viscosity of from 16,000 to about 18,000 centipoise at 25° C., a nominal functionality of from about 2.8 to about 5, and a hydroxyl value of from about 750 to about 850 mgKOH/g. Suitable second polyols are commercially available from Arch Chemicals of Norwalk, Conn.

Typically, the second polyol is present in an amount of from about 5 to about 50 parts by weight, more typically from about 10 to about 40 parts by weight, and most typically from about 15 to about 30 parts by weight, based on 100 parts by weight of the resin composition or, alternatively, based on 100 parts by weight of all non-isocyanate components used to make the polyurethane foam. The amount of the second polyol may vary outside of the ranges above, but is typically a whole or fractional value within those ranges. As such, the second polyol is typically present in greater amounts than the first polyol to further temper and sustain the exotherm generated during the formation of the polyurethane foam and thus minimize the adverse effects of the exotherm on physical properties, such as color, cell structure, surface characteristics, and adhesion, of the polyurethane foam while other properties, such as density and thermal resistivity, are maximized by the first polyol.

The resin composition may also include one or more bio-based polyols, which are different from the first and second polyols. Bio-based polyols are compounds having one or more hydroxyl groups that are formed from renewable resources, such as soy beans. Specific, non-limiting, examples of bio-based polyols that are suitable for the purposes of the subject invention are glycerine, castor oil, and soy-based polyols. For purposes of the present invention, a particularly suitable bio-based polyol is glycerine.

If present, the bio-based polyol is typically present in an amount of from about 0.1 to about 40 parts by weight, more typically from about 0.5 to about 10 parts by weight, and most typically from about 0.5 to about 5 parts by weight based on 100 parts by weight of the resin composition or, alternatively, based on 100 parts by weight of all non-isocyanate components used to make the polyurethane foam. The amount of the bio-based polyol may vary outside of the ranges above, but is typically a whole or fractional value within those ranges.

It is to be appreciated that the resin composition may further include an additional polyol, which is different from the first, second, and bio-based polyols. The resin composition may include one ore more additional polyols and typically includes a combination of additional polyols. The additional polyol includes one or more hydroxyl groups, typically at least two hydroxyl groups. The additional polyol can be an aliphatic polyol, cycloaliphatic polyol, aromatic polyol, a heterocyclic polyol, or a combination thereof, so long as it is different than the first, second, and bio polyols. For purposes of the present invention, particularly suitable additional polyols are (1) a Mannich polyol having a molecular weight of from about 322 to about 522 g/mol, a nominal functionality of from about 2.7 to about 3.7, and a hydroxyl value of from about 325 to about 525 mgKOH/g and (2) a polyether polyol having a molecular weight of from about 250 to about 600 g/mol, a nominal functionality of from about 1.8 to about 2.8, and a hydroxyl value of from about 200 to about 400 mgKOH/g. Suitable additional polyols are commercially available from Huntsman of The Woodlands, Tex., and Oxid L.P. of Houston, Tex.

As set forth above, the isocyanate component and the resin composition are reacted in the presence of the physical blowing agent having at least 4 carbon atoms. As is also set forth above, the physical blowing agent having at least 4 carbon atoms can be included in the resin composition, in which case the resin composition is partially reacted, with the reaction occurring in the presence of the physical blowing agent having at least 4 carbon atoms The term “physical blowing agent”, as it is used herein, refers to blowing agents that do not chemically react with the isocyanate component and/or polyol to provide a blowing gas. The physical blowing agent having at least 4 carbon atoms can be a gas at temperatures up to and including exotherm foaming temperatures. Alternatively, the physical blowing agent having at least 4 carbon atoms can be a liquid at temperatures up to exotherm foaming temperatures. When the physical blowing agent having at least 4 carbon atoms is liquid, the physical blowing agent having at least 4 carbon atoms typically evaporates into a gas when heated, and will typically return to a liquid when cooled to ambient atmospheric temperatures. Typically, the physical blowing agent having at least 4 carbon atoms is a liquid. Further, the physical blowing agent having at least 4 carbon atoms is typically a hydrofluorocarbon (HFC). As such, the physical blowing agent having at least 4 carbon atoms typically has the following chemical formula: C_{X}F_{Y}H_{Z}, wherein X≧4, Y≧1, and Z=(2X+2)−Y.

The physical blowing agent having at least 4 carbon atoms is typically an HFC and has zero ozone depletion potential. Examples of suitable physical blowing agents having at least 4 carbon atoms, for purposes of the subject invention, include hexafluorobutane isomers and pentafluorobutane isomers. For purposes of the present invention, a particularly suitable physical blowing agent having at least 4 carbon atoms is 1,1,1,3,3-pentafluorobutane.

As set forth above, the physical blowing agent having at least 4 carbon atoms is typically included in the resin composition. The physical blowing agent having at least 4 carbon atoms is typically present in an amount of from about 5 to about 30 parts by weight, more typically from about 7 to about 25 parts by weight, and most typically from about 9 to about 20 parts by weight based on 100 parts by weight of the resin composition or, alternatively, based on 100 parts by weight of all non-isocyanate components used to make the polyurethane foam. The amount of the physical blowing agent having at least 4 carbon atoms may vary outside of the ranges above, but is typically a whole or fractional value within those ranges. At the above amounts and in combination with the first and second polyols, the physical blowing agent having at least 4 carbon atoms is a viable alternative to ozone depleting blowing agents. That is, the present invention enables the efficient formation of polyurethane foam, which has minimal density and maximum thermal resistivity, with the physical blowing agent having at least 4 carbon atoms.

It is to be also appreciated that an additional physical blowing, having less than or equal to 3 carbon atoms, may also be used to form the polyurethane foam. The additional physical blowing agent is typically a hydrofluorocarbon (HFC). The additional physical blowing agent can be a gas at temperatures up to and including exotherm foaming temperatures. Alternatively, the additional physical blowing agent can be a liquid at temperatures up to exotherm foaming temperatures. When the additional physical blowing agent is liquid, the additional physical blowing agent typically evaporates into a gas when heated, and will typically return to a liquid when cooled to ambient atmospheric temperatures. Typically, the additional physical blowing agent having less than or equal to 3 carbon atoms is a liquid. Suitable additional physical blowing agents having less than or equal to 3 carbon atoms include: difluoromethane; 1,1,1,2-tetrafluoroethane; 1,1,2,2-tetrafluoroethane; 1,1-difluoroethane; 1,2-difluoroethane; 1,1,1,3,3-pentafluoropropane; and 1,1,1,2,3,3,3-heptafluoropropane. For purposes of the present invention, particularly suitable additional physical blowing agents are 1,1,1,2,3,3,3-heptafluoropropane and 1,1,1,3,3-pentafluoropropane.

If present, the additional physical blowing agent having less than or equal to 3 carbon atoms is typically included in the resin composition. The additional physical blowing agent is typically present in an amount of less than 20 parts by weight, more typically in an amount of from about 0.1 to about 15 parts by weight, and most typically from about 0.5 to about 12 parts by weight based on 100 parts by weight of the resin composition or, alternatively, based on 100 parts by weight of all non-isocyanate components used to make the polyurethane foam. The amount of the additional physical blowing may vary outside of the ranges above, but is typically a whole or fractional value within those ranges.

In one embodiment the physical blowing agent having at least 4 carbon atoms and the additional physical blowing agent having less than or equal to 3 carbon atoms are present in a weight ratio of from about 19:1 to about 1:2, more typically from about 15:1 to about 1:1, and most typically from about 9:1 to about 2:1. The weight ratio of the physical blowing agent having at least 4 carbon atoms to the additional physical blowing agent having less than or equal to 3 carbon atoms may vary outside of the ranges above, but is typically a whole or fractional value within those ranges.

It is to be appreciated that a chemical co-blowing agent may also be present. If present, the chemical co-blowing agent is typically included in the resin composition. The term “chemical co-blowing agent”, as it is used herein, refers to blowing agents which chemically react with the isocyanate or with other components in the resin composition to release a gas for foaming the polyurethane during the reaction of the isocyanate component and the resin composition. For purposes of the present invention, a particularly suitable chemical co-blowing agent is water.

The resin composition of the present invention may also include one or more flame retardants. In the event of a fire after the polyurethane foam has been applied to the substrate, the flame retardant helps to retard fire progression of the polyurethane foam. Suitable examples of flame retardants include tris(1-chloro-2-propyl)phosphate (TCPP), tetrabromophthalate diol, tris(chloroisopropyl) phosphate, tricresyl phosphate, tris(2-chloroethyl)phosphate, tris(2,3-dibromopropyl)phosphate. In addition to halogen-substituted phosphates, the flame retardant may also include reactive hydroxyl groups. For example, the flame retardant can be a novolac polyol, which is different than the first, second, bio-based, and additional polyols described above. Novolac polyols are also known in the art as “novolac resin” or “phenolic polyol.” In addition to halogen-substituted phosphates, it is also possible to use various other inorganic or organic flame retardants. For purposes of the present invention, a particularly suitable flame retardant TCPP.

If present, flame retardant is typically present in an amount of less than 40 parts by weight, more typically from about 1 to about 30 parts by weight, and most typically from about 5 to about 25 parts by weight based on 100 parts by weight of the resin composition or, alternatively, based on 100 parts by weight of all non-isocyanate components used to make the polyurethane foam. The amount of the flame retardant may vary outside of the ranges above, but is typically a whole or fractional value within those ranges.

The resin composition of the present invention may also include a surfactant. Examples of suitable surfactants include salts of sulfonic acids, for example, alkali metal salts or ammonium salts of fatty acids such as oleic or stearic acid, of dodecylbenzene- or dinaphthylmethanedisulfonic acid, and ricinoleic acid; foam stabilizers, such as siloxaneoxyalkylene copolymers and other organopolysiloxanes, oxyethylated alkyl-phenols, oxyethylated fatty alcohols, paraffin oils, castor oil esters, ricinoleic acid esters, Turkey red oil and groundnut oil; and cell regulators, such as paraffins, fatty alcohols, and dimethylpolysiloxanes. For purposes of the present invention, particularly suitable surfactants are (1) a non-silicone surfactant and (2) a silicone foam stabilizer.

If present, surfactant is typically present in an amount of less than 6 parts by weight, more typically in an amount of from about 0.5 to about 5 parts by weight, and most typically from about 1 to about 4 parts by weight based on 100 parts by weight of the resin composition or, alternatively, based on 100 parts by weight of all non-isocyanate components used to make the polyurethane foam. The amount of the surfactant may vary outside of the ranges above, but is typically a whole or fractional value within those ranges.

The resin composition of the present invention may also include a catalyst system. The catalyst system may include a curing catalyst, a blow catalyst, and combinations thereof. The catalyst system may be employed to accelerate the reaction of the isocyanate component and the resin composition. Curing catalysts also function to shorten tack time, promote green strength, and prevent foam shrinkage. Suitable curing catalysts are organometallic catalysts, typically organo-lead catalysts, although it is possible to employ metals such as tin, titanium, copper, mercury, cobalt, nickel, iron, vanadium, antimony, bismuth, lithium, and manganese. For purposes of the present invention, a particularly suitable curing catalyst is a dibutyl tin-based catalyst.

If included in the catalyst system, the curing catalyst is typically present in an amount of less than 5 parts by weight, more typically from about 0.1 to about 3 parts by weight, and most typically from about 0.2 to about 2 parts by weight based on 100 parts by weight of the resin composition or, alternatively, based on 100 parts by weight of all non-isocyanate components used to make the polyurethane foam. The amount of the curing catalyst may vary outside of the ranges above, but is typically a whole or fractional value within those ranges.

As set forth above, blow catalysts may also be included in the catalyst system. The blow catalysts promote urethane linkage formation. For purposes of the present invention, a particularly suitable blow catalyst is an amine catalyst.

If included in the catalyst system, the blow catalyst is typically present in an amount of less than 5 parts by weight, more typically from about 0.5 to about 4 parts by weight, and most typically from about 1 to about 3 parts by weight based on 100 parts by weight of the resin composition or, alternatively, based on 100 parts by weight of all non-isocyanate components used to make the polyurethane foam. The amount of the blow catalyst may vary outside of the ranges above, but is typically a whole or fractional value within those ranges.

The resin composition may also include one or more additives. Suitable additives may include, but are not limited to, chain-extenders, chain-terminators, processing additives, adhesion promoters, anti-oxidants, defoamers, anti-foaming agents, water scavengers, molecular sieves, fumed silicas, ultraviolet light stabilizers, fillers, thixotropic agents, silicones, dyes and colorants, indicator dyes, inert diluents, and combinations thereof.

The subject invention also includes a method of forming the polyurethane foam on the substrate. The polyurethane foam results from an exothermic reaction of the isocyanate component and the resin composition, in the presence of the physical blowing agent having at least 4 carbon atoms. The method includes numerous steps, including the steps of providing the isocyanate component, providing the resin composition, and providing the physical blowing agent having at least 4 carbon atoms. The physical blowing agent having at least 4 carbon atoms can be provided as part of the resin composition or provided separately. In other words, the physical blowing agent having at least 4 carbon atoms can be included in the resin composition, or provided separately. Typically, the physical blowing agent having at least 4 carbon atoms is included in the resin composition.

The isocyanate component and the resin composition are typically formulated off-site and delivered to an area where they are used. Typically, the isocyanate component and the resin composition, collectively known as a polyurethane system are supplied together.

The method also includes the step of combining the isocyanate component and the resin composition, in the presence of the physical blowing agent having at least 4 carbon atoms to form a reaction mixture. It is to be appreciated that the reaction between the isocyanate component and the resin composition begins upon mixing thereof. As such, the reaction mixture typically includes at least some polyurethane chains that comprise the reaction product of the isocyanate component and the resin composition. However, the reaction mixture typically includes unreacted isocyanate and resin composition in an amount sufficient to allow spray application of the reaction mixture. A reaction temperature of the reaction mixture is typically greater than or equal to about 80° C., more typically greater or equal to about 90° C., and most typically greater than or equal to about 100° C. That is, the isocyanate component and the resin composition (comprising the first and second polyols) typically react and provide an exotherm sufficient increase the reaction temperature to the values set forth above and evaporate the blowing agent having at least 4 carbon atoms and to efficiently foam the reaction mixture and ultimately form the polyurethane foam having excellent density and thermal resistivity.

The method further includes the step of applying the reaction mixture onto the substrate to form the polyurethane foam. The reaction mixture can be applied with any application technique, such as spraying, pouring, or injection molding. Typically, the steps of combining the isocyanate component and the resin composition to form the reaction mixture and applying the reaction mixture onto the substrate to form the polyurethane foam are conducted in succession. That is, the isocyanate component and the resin composition are mixed and then applied onto the substrate by spraying, e.g. spray applied with a spray gun having a mixing chamber, typically using a fixed ratio proportioning system. The fixed ratio proportioning system typically includes a resin composition supply vessel, an isocyanate component supply vessel, a spray machine, and the spray gun having the mixing chamber. The resin composition is pumped in a first stream from the resin composition supply vessel to the spray machine. The isocyanate component is pumped in a second stream, separate from the resin composition, from the isocyanate component supply vessel to the spray machine. The isocyanate component and resin composition are heated and pressurized in the spray machine and supplied to the spray gun in two separate heated hoses. More specifically, the method typically includes the step of heating the isocyanate component and the resin composition to a temperature of from about 25 to about 60, and more typically to a temperature of from about 30 to about 55, ° C. prior to the step of combining the isocyanate component and the resin composition to form the reaction mixture. The isocyanate component and resin composition are then moved to the mixing chamber of the spray gun, which is used to mix the isocyanate component and the resin composition to form the reaction mixture as well as spray the reaction mixture onto the substrate.

Typically, the reaction mixture is spray applied at a spray rate of from about 1 to about 40, more typically from about 4 to about 35, and most typically at a spray rate of from about 6 to about 30, lbs/min. Also, the mixture is typically spray applied at a dynamic pressure of greater than about 250 psi and most typically at a dynamic pressure of from about 800 to about 1600 psi. It is contemplated that the reaction mixture may be spray applied at any rate or range of rates within the ranges set forth above. Similarly, it is contemplated that the reaction mixture may be spray applied at any pressure or range of pressures within the ranges set forth above. Typically, the reaction mixture is spray applied at ambient atmospheric temperatures.

In one embodiment, the reaction mixture is spray applied at a temperature of from about 5° C. to about 40° C. In another embodiment, the reaction mixture is spray applied a temperature of from about −10° C. to about 5° C. That is, the polyurethane system can be selected to react at certain temperatures to form a polyurethane foam having optimum properties. For example, a cold temperature grade polyurethane system can be selected for application in the winter months.

The reaction mixture is typically spray applied at a spray angle of from about 20° to about 160°, and more typically from about 70° to about 110° relative to the substrate, in well-defined and properly directed passes to form lifts, or layers of the polyurethane foam. Typically, the lifts have a thickness of from about 10 mm to about 60 mm. Typically, the lifts have a thickness of 50 mm or less for efficiency and to control an exotherm, which results from the exothermic reaction of the isocyanate component and the resin composition. Should the thickness of a lift exceed about 50 mm, the exotherm generated could cause the lift to discolor, split, scorch, burn, and/or inadequately adhere to the substrate. If the polyurethane foam having a desired thickness of greater than 50 mm is required, multiple lifts are formed to achieve the desired thickness.

The substrate upon which the reaction mixture is applied may be any surface but is typically a surface of a residential or commercial structure or building. Typically, the substrate is a wall, floor, or ceiling of the building. Most typically, the substrate is a wall of a building and the reaction mixture is spray applied on the wall of the building on-site, i.e., at a construction location. It is also contemplated that the substrate upon which the reaction mixture is spray applied may be a surface of a vehicle or machine component.

The resulting polyurethane foam typically has a closed-cell content of at least about 90% as measured in accordance with ASTM D 6226-98. The polyurethane foam typically has an in-place density of less than about 3.0, more typically less than about 2.6, even more typically less than 2.4, and most typically less than about 2.2 pcf as measured in accordance with ASTM D 1622-98. Further, the polyurethane foam has a thermal conductivity of less than 0.2 Btu/h·ft²·° F. when tested in accordance with ASTM test method C518.

The following examples are meant to illustrate the invention and are not to be viewed in any way as limiting to the scope of the invention.

### EXAMPLES

Examples 1-5 and Comparative Example 1 are polyurethane systems that are used to form polyurethane foams. Referring now to Tables 1 and 2, a series of polyurethane systems are described. The polyurethane systems of Examples 1 and 2 are in accordance with the present invention. The polyurethane system of Comparative Example 1 is not in accordance with the present invention and is included for comparative purposes. The amounts in Tables 1 and 2 are in parts by weight based on 100 parts by weight resin composition.

Referring to Tables 1 and 2, an isocyanate index at which the resin compositions are reacted with an isocyanate component to form the polyurethane foams of Examples 1-5 and Comparative Example 1 is also included. The resin composition and the isocyanate component are combined in a spray nozzle to form individual reaction mixtures. Each individual reaction mixture is spray applied onto a substrate to form the polyurethane foams.

During formation of the polyurethane foams of Examples 1-5 and Comparative Example 1, Cream Time (CT) and Gel Time (GT) are measured and included in Tables 1 and 2. Once formed, the density of the polyurethane foams of Examples 1-5 and Comparative Example 1 is measured and also recorded in Tables 1 and 2.

TABLE 1

| | | |
|---|---|---|
| Comparative | | |
| Example 1 | Example 1 | Example 2 |

Resin Composition

| | | | |
|---|---|---|---|
| Polyol A | — | 0.500 | 5.000 |
| Polyol B | 19.600 | 19.100 | 14.600 |
| Polyol C | 10.000 | 10.000 | 10.000 |
| Polyol D | 20.000 | 20.000 | 20.000 |
| Polyol E | 1.500 | 1.500 | 1.500 |
| Flame Retardant | 25.000 | 25.000 | 25.000 |
| Surfactant A | 2.000 | 2.000 | 2.000 |
| Surfactant B | 2.000 | 2.000 | 2.000 |
| Catalyst A | 0.800 | 0.800 | 0.800 |
| Catalyst B | 1.800 | 1.800 | 1.800 |
| Blowing Agent A | 9.570 | 9.570 | 9.570 |
| Blowing Agent B | 1.430 | 1.430 | 1.430 |
| Blowing Agent C | 5.000 | 5.000 | 5.000 |
| Blowing Agent D | 1.300 | 1.300 | 1.300 |
| Total | 100.000 | 100.000 | 100.000 |

Isocyanate Component

| | | | |
|---|---|---|---|
| Isocyanate Index | 110 | 110 | 110 |

Results

| | | | |
|---|---|---|---|
| CT (s) | 0.5 | 0.5 | 0.37 |
| GT (s) | 1.8 | 1.9 | 1.7 |
| Density (pcf) | 2.14 | 2.10 | 1.99 |

TABLE 2

| | | | |
|---|---|---|---|
| Component | Example 3 | Example 4 | Example 5 |

Resin Composition

| | | | |
|---|---|---|---|
| Polyol A | 0.500 | 2.500 | 5.000 |
| Polyol B | 19.100 | 17.100 | 14.600 |
| Polyol C | 10.000 | 10.000 | 10.000 |
| Polyol D | 20.000 | 20.000 | 20.000 |
| Polyol E | 1.500 | 1.500 | 1.500 |
| Flame Retardant | 25.000 | 25.000 | 25.000 |
| Surfactant A | 2.000 | 2.000 | 2.000 |
| Surfactant B | 2.000 | 2.000 | 2.000 |
| Catalyst A | 0.800 | 0.800 | 0.800 |
| Catalyst B | 1.800 | 1.800 | 1.800 |
| Blowing Agent A | 13.920 | 13.920 | 13.920 |
| Blowing Agent B | 2.080 | 2.080 | 2.080 |
| Blowing Agent C | — | — | — |
| Blowing Agent D | 1.300 | 1.300 | 1.300 |
| Total | 100.000 | 100.000 | 100.000 |

Isocyanate Component

| | | | |
|---|---|---|---|
| Isocyanate Index | 110 | 110 | 110 |

Results

| | | | |
|---|---|---|---|
| CT (s) | 0.44 | 0.3 | 0.3 |
| GT (s) | 1.9 | 1.8 | 1.7 |
| Density (pcf) | 2.15 | 2.07 | 2.03 |

Polyol A is based upon ethylene diamine and has 100% ethylene oxide capping, a molecular weight of from about 224 to about 561 g/mol, a nominal functionality of from about 3.8 to about 4.2, and a hydroxyl value of from about 900 to about 1,000 mgKOH/g.

Polyol B is based upon ethylene diamine and has 25% ethylene oxide capping, a molecular weight of from about 230 to about 330 g/mol, a nominal functionality of from about 2.8 to about 5, and a hydroxyl value of from about 750 to about 850 mgKOH/g.

Polyol C is a Mannich polyol having a molecular weight of from about 400 to about 500 g/mol, a nominal functionality of from about 3 to about 3.5, and a hydroxyl value of from about 400 to about 500 mgKOH/g.

Polyol D is a polyether polyol having a molecular weight of from about 250 to about 600 g/mol, a nominal functionality of from about 1.8 to about 2.8, and a hydroxyl value of from about 200 to about 400 mgKOH/g.

Polyol E is a bio-based polyol.

Flame Retardant is a mixture of halogen-substituted phosphate and novolac polyol.

Surfactant A is a non-silicone surfactant.

Surfactant B is silicone foam stabilizer.

Catalyst A is a dibutyl tin based catalyst.

Catalyst B is an amine catalyst.

Blowing Agent A is 1,1,1,3,3-pentafluorobutane.

Blowing Agent B is 1,1,1,2,3,3,3-heptafluoropropane.

Blowing Agent C is 1,1,1,3,3-pentafluoropropane.

Blowing Agent D is water.

Isocyanate Component is a mixture of polymeric and monomeric isocyanates.

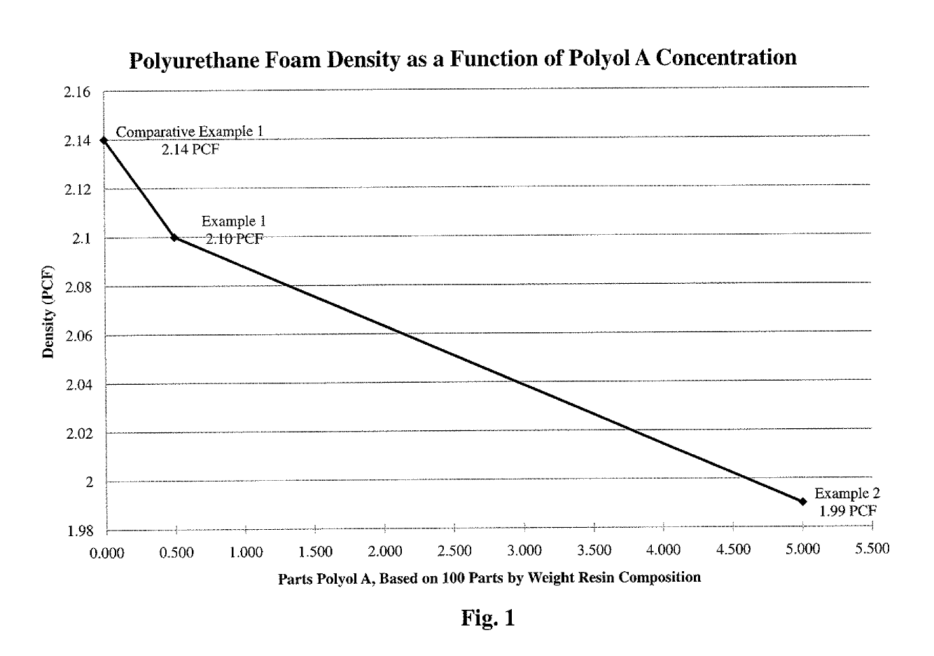

Referring now to Table 1 and FIG. 1, the resin compositions of Comparative Example 1, Example 1, and Example 2 all include Blowing Agent A, 1,1,1,3,3-pentafluorobutane, which is a physical blowing agent having at least 4 carbon atoms. Further, the resin composition of Comparative Example 1 does not include Polyol A and the resin compositions of Examples 1 and 2 include Polyol A, which is a polyol based upon ethylene diamine having about 100% ethylene oxide capping. In reference to Comparative Example 1, Example 1, which employs 0.5 PBW Polyol A, forms a polyurethane foam having significantly reduced foam density. Further, as the amount of Polyol A in the resin composition increases to 5 PBW in Example 2 and the amount of the blowing agents, including Blowing Agent A, remain unchanged, the density of the polyurethane foam formed therefrom decreases. That is, the mere inclusion of Polyol A increases the foaming efficiency of the polyurethane system—Polyol A allows for formation of the polyurethane foam having minimum density with a fixed amount of the physical blowing agent having at least 4 carbon atoms.

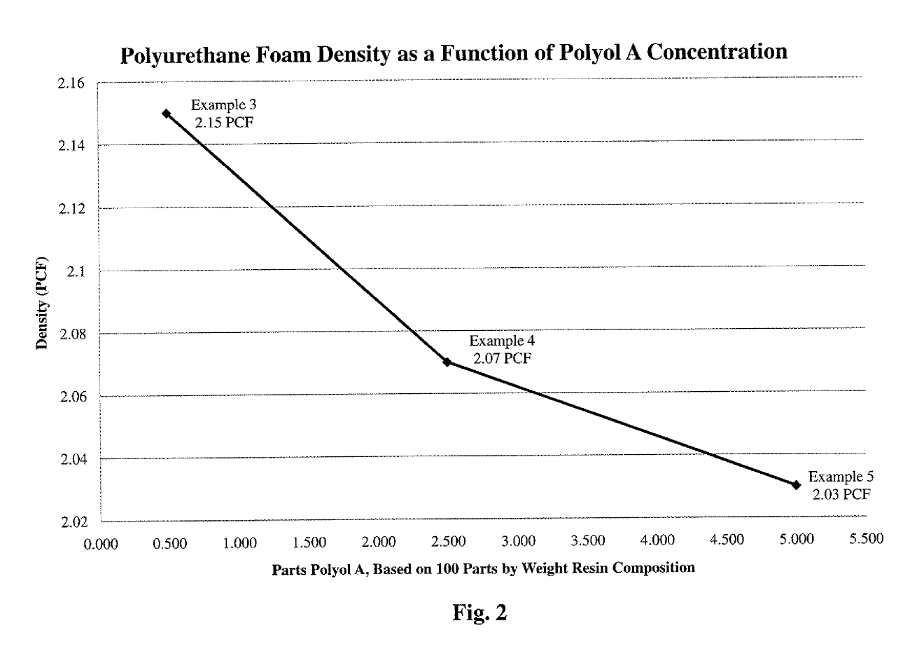

Referring now to Table 2 and FIG. 2, the resin compositions of Examples 3, 4, and 5 all include Blowing Agent A, 1,1,1,3,3-pentafluorobutane, which is a physical blowing agent having at least 4 carbon atoms. Further, the resin compositions of Examples 3, 4, and 5 include Polyol A, which is a polyol based upon ethylene diamine and having about 100% ethylene oxide capping. Here again, as the amount of Polyol A in the resin composition increases and the amount of the blowing agents, including Blowing Agent A, remain unchanged, the density of the polyurethane foam formed therefrom decreases. That is, as the amount of Polyol A increases the foaming efficiency of the polyurethane system increases—Polyol A allows for formation of the polyurethane foam having minimum density with a fixed amount of the physical blowing agent having at least 4 carbon atoms.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

1. A resin composition comprising:
a first polyol based upon ethylene diamine and having about 100% ethylene oxide capping, said first polyol present in an amount of from about 0.3 to about 15 parts by weight based on 100 parts by weight of said resin composition;
a second polyol different from said first polyol; and
a physical blowing agent having at least 4 carbon atoms.

2. A resin composition as set forth in claim 1 wherein said physical blowing agent is a hydrofluorocarbon.

3. A resin composition as set forth in claim 2 wherein said physical blowing agent has the following chemical formula:
C_{X}F_{Y}H_{Z}
wherein X≧4, Y≧1, and Z=(2X+2)−Y.

4. A resin composition as set forth in claim 2 wherein said physical blowing agent is 1,1,1,3,3-pentafluorobutane.

5. A resin composition as set forth in claim 1 wherein said physical blowing agent is present in an amount of from about 5 to about 30 parts by weight based on 100 parts by weight of said resin composition.

6. A resin composition as set forth in claim 1 further comprising an additional physical blowing having less than or equal to 3 carbon atoms.

7. A resin composition as set forth in claim 6 wherein said physical blowing agent and said additional physical blowing agent are present in a weight ratio of from about 19:1 to about 1:2.

8. A resin composition as set forth in claim 1 wherein said second polyol is based upon ethylene diamine and has a viscosity of from about 16,000 to about 18,000 centipoise at 25° C.

9. A resin composition as set forth in claim 1 wherein said second polyol is present in an amount of from about 5 to about 50 parts by weight based on 100 parts by weight of said resin composition.

10. A polyurethane foam comprising a reaction product of:
an isocyanate component; and
a resin composition comprising;
a first polyol based upon ethylene diamine and having about 100% ethylene oxide capping, the first polyol present in an amount of from about 0.3 to about 15 parts by weight based on 100 parts by weight of the resin composition, and
a second polyol different from the first polyol;
in the presence of a physical blowing agent having at least 4 carbon atoms.

11. A polyurethane foam as set forth in claim 10 wherein the physical blowing agent is a hydrofluorocarbon.

12. A polyurethane foam as set forth in claim 11 wherein the physical blowing agent has the following chemical formula:
C_{X}F_{Y}H_{Z}
wherein X≧4, Y≧1, and Z=(2X+2)−Y.

13. A polyurethane foam as set forth in claim 10 wherein the physical blowing agent is 1,1,1,3,3-pentafluorobutane.

14. A polyurethane foam as set forth in claim 10 wherein the physical blowing agent is present in the resin composition and wherein the physical blowing agent is present in an amount of from about 5 to about 30 parts by weight based on 100 parts by weight of the resin composition.

15. A polyurethane foam as set forth in claim 10 further formed in the presence of an additional physical blowing agent having less than or equal to 3 carbon atoms.

16. A polyurethane foam as set forth in claim 10 wherein the second polyol is based upon ethylene diamine and has a viscosity of from about 16,000 to about 18,000 centipoise at 25° C.

17. A polyurethane foam as set forth in claim 10 wherein the second polyol is present in the resin composition in an amount of from about 5 to about 50 parts by weight based on 100 parts by weight of the resin composition.

18. A polyurethane foam as set forth in claim 10 having a density of less than 3.0 pcf.

19. A polyurethane foam as set forth in claim 18 having thermal conductivity of less than 0.2 Btu/h·ft²·° F.

20. A method of forming a polyurethane foam on a substrate, the polyurethane foam comprising the reaction product of an isocyanate component and a resin composition comprising a first polyol and a second polyol, in the presence of a physical blowing agent having at least 4 carbon atoms, said method comprising the steps of:
A. providing the isocyanate component;
B. providing the resin composition comprising;
the first polyol based upon ethylene diamine and having about 100% ethylene oxide capping, the first polyol present in an amount of from about 0.3 to about 15 parts by weight based on 100 parts by weight of the resin composition,
the second polyol different than the first polyol, and
the physical blowing agent having at least 4 carbon atoms;
C. combining the isocyanate component and the resin composition to form a reaction mixture;
D. applying the reaction mixture onto the substrate to form the polyurethane foam thereon.

21. A method as set forth in claim 20 wherein the reaction mixture exceeds a reaction temperature of about 80° C.
